(19) United States
(12) Patent Application Publication
(10) Pub. No.: US 2007/0074696 A1
(43) Pub. Date: Apr. 5, 2007

(54) Alignment feature for casting and method

(76) Inventor: T. Yomi Obidi, Melrose Park, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/243,596

(22) Filed: Oct. 5, 2005

(51) Int. Cl. F02F 7/00; B21K 3/00

(52) U.S. Cl. 123/195 R; 29/888.01

(57) ABSTRACT

An alignment feature includes a first component (400) having a first mating surface (402) and at least one integral protrusion (404). A second component (408) has a second mating surface (410) and at least one opening (412). The first component (400) is arranged and constructed to connect to the second component-(408) along the first (402) and second (410) mating surfaces, and the at least one integral protrusion (404) is appropriately sized to have a snug fit with the opening (412).

### FIELD OF THE INVENTION

This invention relates to component casting and machining, including but not limited to alignment features for metal castings.

### BACKGROUND OF THE INVENTION

Various engine components are manufactured using a casting process, often followed by a machining or finishing process. Such components are typically referred to as “cast” components or “castings” to denote the casting process for making a component that precedes the machining or finishing process. This type of manufacture is especially useful when manufacturing large engine components, such as crankcases, cylinder heads, crankshafts, and so forth.

Features on cast components often shift with respect to their nominal position. This condition is called “core shift,” wherein a core used to form molten metal shifts during the casting process and before the metal has adequately cooled and hardened in a mold. Core shift is one of the reasons why machining of castings is necessary to produce usable components. Machining will typically clean-up and define the size, shape, and location of various features on a casting. These features include functional areas of the casting, as well as areas of the casting that are used to interface with other components.

A typical method of aligning a cast component for assembly with one or more other components is with the use of dowel pins. Dowel pins are usually strengthened steel cylinders that are press-fitted into a hole on a first component, such that a portion of the pin protrudes above a surface. The portion of the pin that protrudes above the surface is inserted into a hole formed into a second component, effectively aligning the first component with the second component.

Dowel pins have typically been used to align large engine components to each other, for instance, an upper portion to a lower portion of a crankcase. Installation of dowel pins requires drilling of holes in respective locations in each component, and installation of at least two pins in one of the components, usually by a press-fitting process. Use of dowel pins is effective, nevertheless, dowel pins are costly to procure, and require drilling of two holes, one in each component, for each dowel used. Moreover, dowel pins require an additional step of press-fitting the pin into one of the components.

Accordingly, there is a need for a more cost effective solution in aligning cast components to each other

### SUMMARY OF THE INVENTION

An alignment feature includes a first component having a first mating surface and at least one integral protrusion. A second component has a second mating surface and at least one opening. The first component is arranged and constructed to connect to the second component along the first and second mating surfaces, and the at least one integral protrusion is appropriately sized to have a snug fit with the opening.

### BRIEF DESCRIPTION OF THE DRAWINGS

FIG. 1 is a perspective view of an upper crankcase for an engine.

FIG. 2. is a perspective view of a lower crankcase for an engine.

FIG. 3. is a detail view in partial cross section of a dowel pin used to align two components.

FIG. 4. is a detail view in partial cross section of a cylindrical alignment feature in accordance with the invention.

FIG. 5. is a detail view in partial cross section of a rectangular alignment feature in accordance with the invention.

FIG. 6. is a detail view in partial cross section of a spherical alignment feature in accordance with the invention.

FIG. 7. is a perspective view of a crankcase assembly with alignment features in accordance with the invention.

FIG. 8. is a flowchart for a method for use with an alignment feature for connecting two or more engine components in accordance with the invention.

### DESCRIPTION OF A PREFERRED EMBODIMENT

The following describes an apparatus for and method of aligning two engine components before connecting one with the other. An integral protrusion is advantageously formed in one engine component. The integral protrusion may be formed by a casting process at the time of forming the engine component, and may be machined to an appropriate shape.

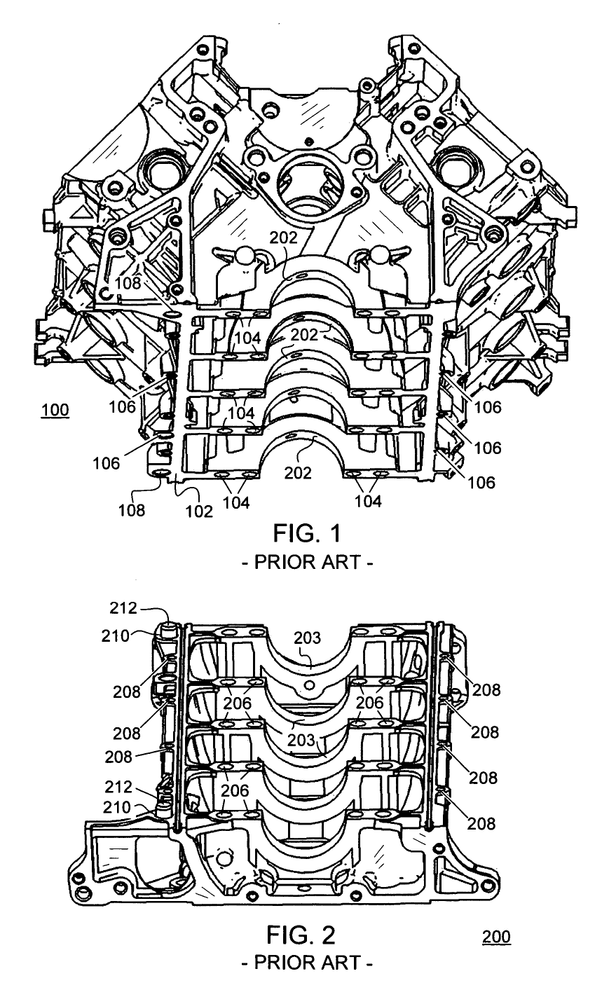

A known configuration of aligning features used between two engine components is shown in FIG. 1 and FIG. 2. An upper crankcase 100 having an upper interface surface 102 is shown. The upper surface 102 is substantially flat, and has a first plurality of mounting holes 104, a second plurality of attachment holes 106, and two dowel holes 108. A lower crankcase 200 is shown in FIG. 2. The lower crankcase 200 is arranged to align and be connected to the upper crankcase 100. When connected, the upper crankcase 100 and the lower crankcase 200 provide structural rigidity to an internal combustion engine, and support a rotating shaft, for instance a crankshaft (not shown) between a plurality of mating bearing surfaces 202 in the upper crankcase 100 and bearing surfaces 203 the lower crankcase 200. The lower crankcase 200 has a lower interface surface 204. The lower surface 204 is substantially flat, and has a first plurality of mounting holes 206, a second plurality of attachment holes 208, and two dowel holes 210. Two dowel pins 212 are inserted, typically by a press-fit operation, into the dowel holes 210.

A plurality of long bolts (not shown) are installed through the holes 206 and 208 in the lower crankcase 200 and threaded into the holes 104 and 106 in the upper crankcase 100 when the two parts are connected. The alignment of the upper crankcase 100 to the lower crankcase 200 is accomplished when the dowel pins 212 are inserted into the dowel holes 108 in the upper crankcase 100. The machining of the dowel holes 108 and 210 is a necessary step for alignment features between components.

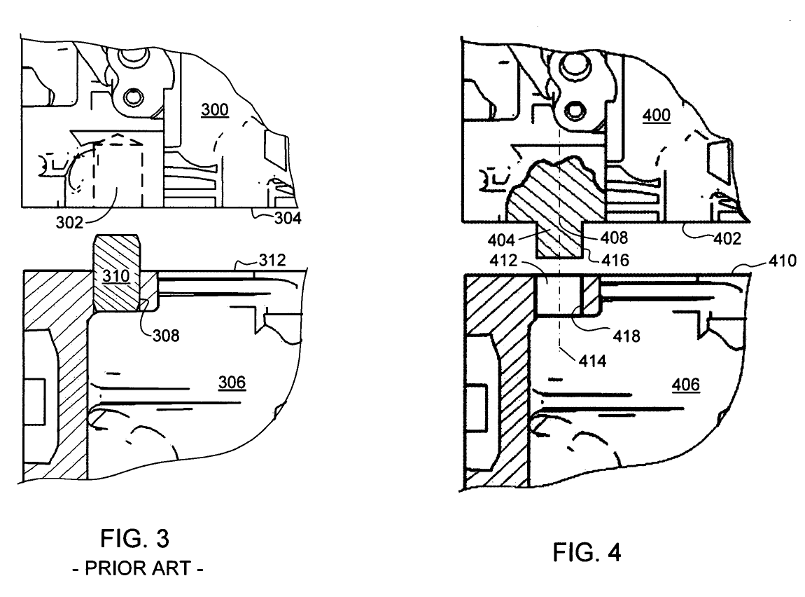

A typical dowel pin alignment feature configuration detail is shown in cross section in FIG. 3. A first engine component 300 has a dowel hole 302 shown with hidden lines. The first engine component 300 has an upper surface 304 that is substantially flat. A second engine component 306 has a dowel hole 308 shown in section. A dowel pin 310 is inserted in the dowel hole 308, usually by use of a press-fit operation. The second engine component 306 has a lower surface 312 that is substantially flat. When the first engine component 300 and the second engine component 306 are connected, the upper surface 304 mates with the lower surface 306, and the components are aligned when the dowel pin 310 is inserted in the dowel hole 302. The cost and time for procurement of the dowel 310 and the added press-fit operation to insert the dowel 310 into the dowel hole 308 may advantageously be avoided as follows.

A detail view in cross section of an integrated feature for alignment of two engine components is shown in FIG. 4. A first engine component 400 has a first surface 402 that is substantially flat for assembly to an other engine component, and may have a profile of within 0.15 mm. An integral protrusion 404 having a centerline 408 is shown in partial cut-away section. The centerline 408 may advantageously be perpendicular to the first surface 402, and in a case where the shape of the integral protrusion is asymmetrical, the centerline 408 may pass through a center of gravity for a cross section of the protrusion 404. If the first engine component 400 is made of metal and manufactured by use of a casting process, the integral protrusion 404 may advantageously be cast as part of the component 400. The centerline 408 may be defined after a machining operation on a raw casting for the component 400 creates the first surface 402 and the shape of the integral protrusion 404. The first engine component 400 may be an upper crankcase for an internal combustion engine. A positional tolerance for a location of the centerline 408 may be within 0.2 mm with respect to a datum (not shown) that lies on the first surface 402.

A second engine component 406 has a second surface 410 that is substantially flat. An opening 412 in the second component 406 is created substantially perpendicularly to the second surface 410, and has a centerline 414. When the first component 400 and the second component 406 are aligned, the centerlines 408 and 414 advantageously coincide to enable insertion of the protrusion 404 in the opening 412. The protrusion 404 may have many shapes. In the case when the shape of the protrusion 404 is cylindrical, the opening 412 is accordingly a circular hole. A diameter of an outer periphery 416 of the protrusion 404 is appropriately selected to have a clearance fit, or, snugly fit, within a peripheral circular surface 418 of the opening 412. The protrusion 404 may have other shapes according to the type of alignment sought for the components 400 and 406. For instance, a cylindrical protrusion provides restriction of relative motion between the components 400 and 406 along the surfaces 402 and 410, and also provides resistance against rotational motion in a direction perpendicular to the centerlines 408 and 414 because of resistance to lateral displacement and rotation provided by the protrusion 404 leaning against the side walls of the opening 412.

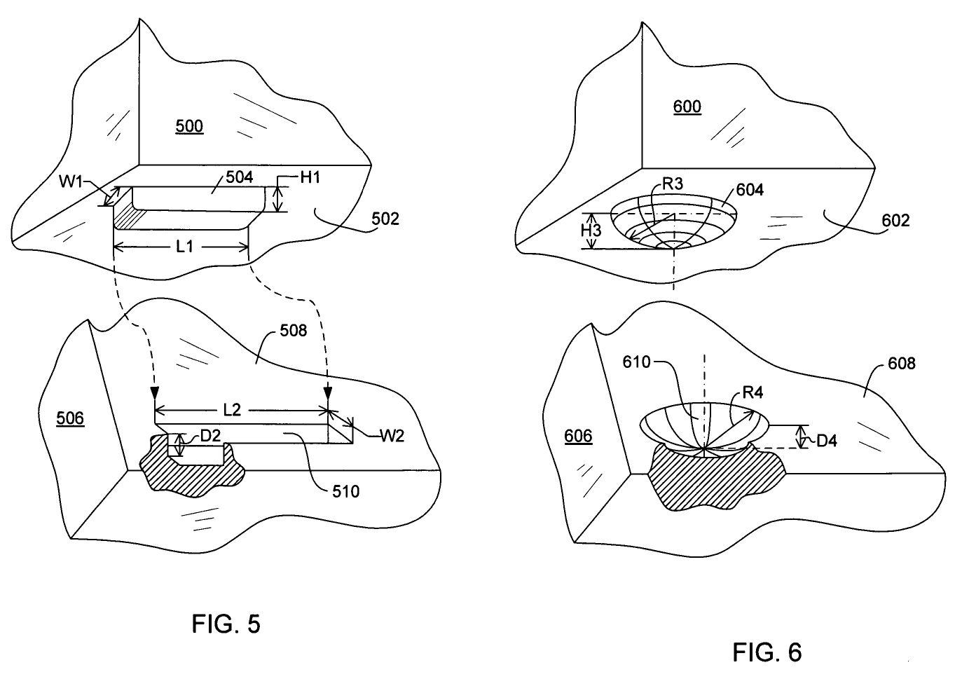

A detail of a perspective view of an alternate embodiment of an integral protrusion is shown in FIG. 5. A first component 500 has an upper surface 502 that is substantially flat, or, has a profile of within 0.15 mm. An integral protrusion 504 has a substantially rectangular shape. The integral protrusion 504 may have rounded edges to facilitate insertion in an opening. The integral protrusion 504 may advantageously be perpendicular to the upper surface 502, and may have a length, L1, a height, H1, and a width, W1. If the first component 500 is made of metal and manufactured by use of a casting process, the integral protrusion 504 may advantageously be cast as part of the component 500. The first component 500 may be an upper crankcase for an internal combustion engine. A positional tolerance for a location of the integral protrusion 504 may be within 0.2 mm with respect to a datum (not shown) that lies on the first surface 502.

A second component 506 has a second surface 508 that is substantially flat. An opening 510 in the second component 506 is created substantially perpendicularly to the second surface 508, has a rectangular shape to correlate with the protrusion 504, and has a length, L2, a width, W2, and a depth, D2. When the first component 500 and the second component 506 are aligned, the protrusion 504 is advantageously inserted in the opening 510. The widths W1 and W2 are arranged to provide a clearance or a snug fit of the protrusion 504 with the opening 510. The height H1 is less than the depth D2 to allow the first surface 502 to touch the second surface 508 when the components 500 and 506 are connected, and the protrusion 504 is inside the opening 510. The length L1 may be less than the length L2 to allow for relative motion during alignment of the components 500 and 506. Alternatively, the length L1 may be arranged for a snug fit of the protrusion 504 within the opening 510 if relative motion of the components 500 and 506 is not desired. The rectangular protrusion of this embodiment provides restriction of relative motion between the components 500 and 506 along the surfaces 502 and 508 in a direction along the widths W1 and W2, provides resistance against rotational motion about a vector perpendicular to the surfaces 502 and 508, but may advantageously allow for some motion in a direction along the lengths L1 and L2.

A detail of a perspective view of another alternate embodiment of an integral protrusion is shown in FIG. 6. A first component 600 has an first surface 602 that is substantially flat, or, has a profile of within 0.15 mm. An integral protrusion 604 has a substantially spherical shape. The integral protrusion 604 may advantageously be perpendicular to the upper surface 602, and may have a height H3 and a radius R3. If the first component 600 is made of metal and manufactured by use of a casting process, the integral protrusion 604 may advantageously be cast as part of the component 600. The first component 600 may be an upper crankcase for an internal combustion engine. A positional tolerance for a location of the integral protrusion 604 may be within 0.2 mm with respect to a datum (not shown) that lies on the upper surface 602.

A second component 606 has a second surface 608 that is substantially flat. An opening 610 in the second component 606 is created substantially perpendicularly to the second surface 608, has a spherical shape to correlate with the protrusion 604, has a radius R4, and a depth, D4. When the first component 600 and the second component 606 are aligned, the protrusion 604 is advantageously inserted in the opening 610. The radii R3 and R4 are arranged to provide a snug fit of the protrusion 604 with the opening 610. The height H3 is less than the depth D4 to allow the first surface 602 to touch the second surface 608 when the components 600 and 606 are connected and the protrusion 604 is inside the opening 610. The spherical protrusion 604 of this embodiment provides restriction of relative motion between the components 600 and 606 along the surfaces 602 and 608, but provides no resistance against rotational motion about a vector either perpendicular or parallel to the surfaces 602 and 608.

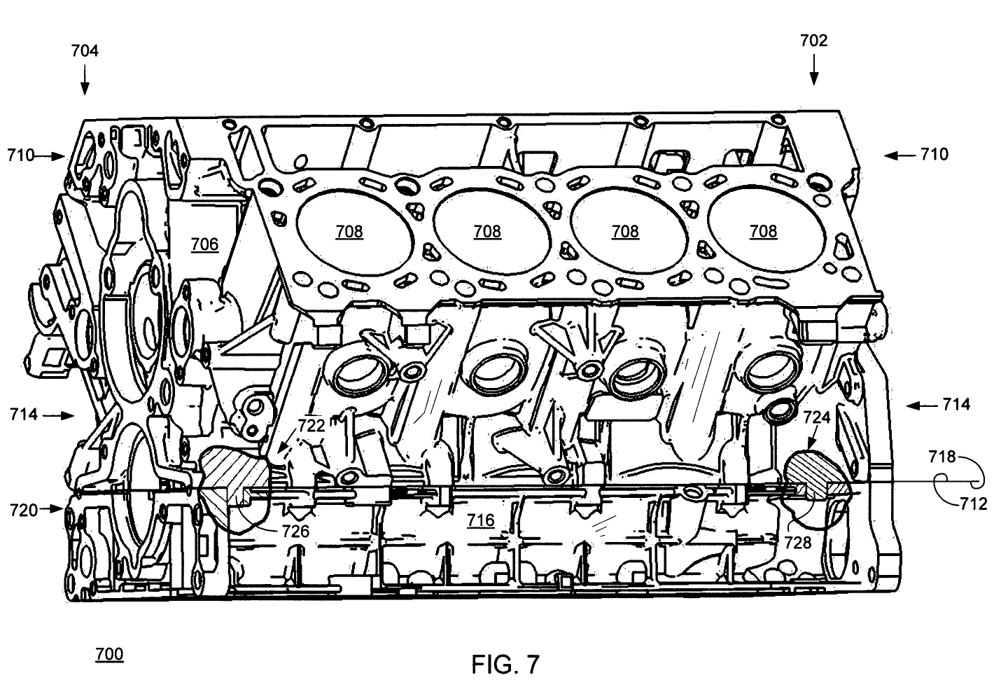

A preferred embodiment for alignment of an engine crankcase assembly 700 having a front end 702 and a rear end 704 is shown in FIG. 7. An upper crankcase 706 for an engine having 8 cylinders arranged in a “V” configuration has plural cylinder openings 708 on a top side 710. The upper crankcase 706 has an interface surface 712 on a bottom side 714. The upper crankcase 706 is connected to a lower crankcase 716. The lower crankcase 716 has an interface surface 718 on an upper side 720. A first alignment feature 722 may align the upper crankcase 706 with the lower crankcase 716 in the rear side 704 of the crankcase assembly 700. A second alignment feature 724 may align the upper crankcase 706 with the lower crankcase 716 in the front side 702 of the crankcase assembly 700. A first protrusion 726 of the first alignment feature 722 may have any shape as discussed, for instance, cylindrical, rectangular, or spherical, but other shapes may be used. A second protrusion 728 of the second alignment feature 724 may also have any shape. The first and second protrusions 726 and 728 may have the same shape, but may advantageously have different shapes that allow for different degrees of freedom in motion during alignment of the two components 706 and 716. For example, the first protrusion 726 may have a cylindrical shape, and the second protrusion 728 may have a rectangular shape. In such a configuration, the first protrusion 726 would restrict motion along the interface 712, and 718, and would make assembly easier for insertion of the second protrusion 728 that would be free to move in only one direction as discussed above. Other combinations of shapes may be used for the first and second protrusions 726 and 728 to accommodate tolerance stack-up and fitting or assembly issues when connecting engine components.

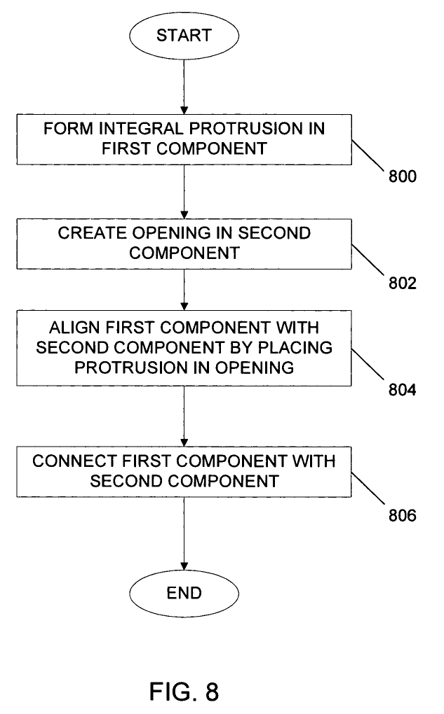

A method for use with an alignment feature for connecting two or more engine components is shown in the flowchart of FIG. 8. An integral protrusion is formed in a first engine component in step 800. The integral protrusion may have any shape appropriate for the application, for instance, a cylindrical, rectangular, spherical shape, and so forth. An opening is created in a second engine component in step 802. The opening has an appropriate shape to accommodate the shape of the protrusion of step 800. The first and second engine components are brought together and aligned in step 804. Alignment may be accomplished by ensuring that the protrusion of step 800 is inserted in the opening of step 802. The first and second engine components are connected in step 806. The connection of the first and second engine components may be accomplished by inserting a plurality of bolts through a plurality of holes in the second component, and threading the bolts in a plurality of holes in the first components.

The step 800 of forming a protrusion may include sub-steps. For example, one might first cast a raw protrusion along with casting an engine component, and then use a machining operation to shape the protrusion to the desired shape. Conversely, one might firs cast the second engine component, and subsequently use drilling or any other machining operation to create the opening in the second engine component in step 802.

The alignment features described herein may advantageously be used to connect different components on an engine, or even cast metal components in other applications. For example, the first component may be an upper crankcase as described, but may also be a cylinder head, a front cover, any type of bracket, and so forth on an engine. Alternatively, the first component may be a motor housing, or any other molded piece, for example, a concrete pillar requiring alignment to a base. Conversely, the second component may be a lower crankcase as described, but may also be an upper crankcase, a cylinder head, a bracket, and so forth for an engine, but may also be a concrete base or any other molded component requiring alignment with other components.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An alignment feature, comprising:
a first component having a first mating surface and at least one integral protrusion;
a second component having a second mating surface and at least one opening;
wherein the first component is arranged and constructed to connect to the second component along the first and second mating surfaces, and wherein the at least one protrusion is appropriately sized to have a snug fit with the opening.

2. The alignment system of claim 1., further comprising a plurality of threaded holes in the first component, a plurality of bosses in the second component, and a plurality of bolts inserted in the plurality of bosses and threaded in the plurality of threaded holes.

3. The alignment system of claim 1, further comprising a second protrusion in the first component that has a clearance fit with a second opening in the second component.

4. The alignment feature of claim 1, wherein the at least one protrusion has a circular cross-section and a centerline, and wherein the centerline is perpendicular to the first mating surface.

5. The alignment feature of claim 1, wherein the at least one opening is a circular hole having a centerline, and wherein the centerline is perpendicular to the second mating surface.

6. The alignment feature of claim 1, wherein the protrusion has at least one of a spherical and a rectangular shape.

7. The alignment feature of claim 1, wherein the first component is made of metal, and wherein the first component is at least one of an upper crankcase, a cylinder head, a front cover, and a bracket.

8. The alignment feature of claim 1, wherein the second component is made of metal, wherein the opening is formed by a machining process, and wherein the second component is at least one of a lower crankcase, an upper crankcase, a cylinder head, and a bracket.

9. A crankcase alignment feature for an engine, comprising:
an upper crankcase having at least one integral protrusion extending from an upper interface;
a lower crankcase having at least one opening formed in a lower interface;
a first plurality of threaded holes in the upper crankcase adjacent to the upper interface;
a second plurality of bosses in the lower crankcase adjacent to the lower interface;
a third plurality of bolts, disposed in the first plurality of threaded holes and passing through the second plurality of bosses;
wherein the at least one integral protrusion is disposed within the at least one opening when the upper crankcase and the lower crankcase are connected to each other.

10. The crankcase alignment feature of claim 9, further comprising a second protrusion extending from the upper interface, and a second opening in the lower interface.

11. The crankcase alignment feature of claim 10, wherein the second protrusion aligns with and is disposed in the second opening when the upper crankcase and the lower crankcase are connected to each other.

12. The crankcase alignment feature of claim 9, wherein the at least one integral protrusion is capable of aligning the upper crankcase to the lower crankcase along the upper interface and the lower interface.

13. The crankcase alignment feature of claim 9., wherein the at least one integral protrusion is capable of withstanding displacement between the upper crankcase and the lower crankcase along a lateral direction.

14. The crankcase alignment feature of claim 9, wherein the at least one integral protrusion has at least one of a cylindrical, spherical, and rectangular shape.

15. A method of aligning a first component to a second component, comprising the steps of:
forming an integral protrusion on the first component;
creating an opening in the second component;
aligning the integral protrusion with the opening;
disposing the integral protrusion in the opening; and
connecting the first engine component with the second engine component.

16. The method of claim 15, wherein the step of forming an integral protrusion is accomplished by applying a machining operation on a raw metal casting.

17. The method of claim 15, wherein the step of creating an opening is accomplished by machining the opening in the second component.

18. The method of claim 15, wherein the step of connecting the first component to the second component includes installing and threading a plurality of bolts.

19. The method of claim 15, wherein the step of connecting the first component to the second component includes mating an first surface of the first engine component to a second surface of the second engine component, and wherein the first surface and the second surface are substantially flat.

20. The method of claim 14, wherein the step of aligning the protrusion with the opening includes restricting a relative motion between the first component and the second component along at least one of a point, a line, and a surface.
